(19) United States
(12) Patent Application Publication
(10) Pub. No.: US 2026/0148994 A1
(43) Pub. Date: May 28, 2026

(54) NEGATIVE ELECTRODE FOR ALL-SOLID-STATE BATTERY, ALL-SOLID-STATE BATTERY CONTAINING THE SAME, AND METHOD FOR MANUFACTURING A NEGATIVE ELECTRODE FOR ALL-SOLID-STATE BATTERY

(71) Applicant: SAMSUNG SDI CO., LTD., Yongin-si (KR)

(72) Inventors: Jiwon HAN, Yongin-si (KR); Seunghyun OH, Yongin-si (KR); Jangwook LEE, Yongin-si (KR); Bohyung LEE, Yongin-si (KR)

(73) Assignee: SAMSUNG SDI CO., LTD., Yongin-si (KR)

(21) Appl. No.: 19/395,567

(22) Filed: Nov. 20, 2025

(30) Foreign Application Priority Data
Nov. 25, 2024 (KR) 10-2024-0169998

(51) Int. Cl. H01M 4/62; H01M 4/02; H01M 4/04; H01M 4/13; H01M 10/0562

(52) U.S. Cl. CPC H01M 4/628; H01M 4/0442; H01M 4/13; H01M 10/0562; H01M 2004/027; H01M 2300/0068

(57) ABSTRACT

Provided is a negative electrode for an all-solid-state battery, an all-solid-state battery including the negative electrode, and a method for manufacturing a negative electrode for an all-solid-state battery, and more particularly to a negative electrode for an all-solid-state battery including a negative electrode current collector and a coating layer on the negative electrode current collector. The negative electrode current collector includes a first region and a second region surrounding the first region, and the second region includes a plurality of irregularities, an all-solid-state battery including the negative electrode, and a method for manufacturing a negative electrode for an all-solid-state battery.

### CROSS-REFERENCE TO RELATED APPLICATIONS

This U.S. non-provisional patent application claims priority under 35 U.S.C. § 119 to Korean Patent Application No. 10-2024-0169998, filed on Nov. 25, 2024, the entire contents of which is hereby incorporated by reference.

### BACKGROUND

The present disclosure herein relates to a negative electrode for an all-solid-state battery, and an all-solid-state battery including the negative electrode, and a method for manufacturing the negative electrode for an all-solid-state battery, and more particularly to a negative electrode for an all-solid-state battery including a negative electrode current collector in which a plasma treatment is performed only on a partial region, and an all-solid-state battery including the negative electrode, and a method for manufacturing the negative electrode for the all-solid-state battery.

Due to industrial demand, development of a battery with high energy density and safety may be advantageous. For example, a lithium-ion battery is commercialized not only in the fields of information related devices and communication devices, but also in the field of automobiles. Since users' safety may be impacted by automobiles, safety is particularly important.

An all-solid-state battery in which an electrolyte solution is substituted with a solid electrolyte is suggested. Since a flammable organic dispersion medium is not used in the all-solid-state battery, the possibility of fire or explosion may be significantly reduced despite the occurrence of a short circuit. Therefore, the all-solid-state battery may have significantly higher safety than the lithium-ion battery in which the electrolyte solution is used.

### SUMMARY

The present disclosure describes a negative electrode for an all-solid-state battery which has a desired or improved adhesion between a negative electrode current collector and a coating layer, and in which a lithium metal layer may grow smoothly in charging and discharging.

The present disclosure also describes an all-solid-state battery desired or improved in lifespan characteristics and rate capability.

The present disclosure also describes a method for manufacturing the negative electrode for the all-solid-state battery which has a desired or improved adhesion between a negative electrode current collector and a coating layer, and in which a lithium metal layer may grow smoothly in charging and discharging.

According to an example embodiment of the present disclosure provides a negative electrode for an all-solid-state battery including a negative electrode current collector, and a coating layer on the negative electrode current collector, wherein the negative electrode current collector includes a first region, and a second region surrounding the first region, and the second region includes a plurality of irregularities.

In an example embodiment of the present disclosure, an all-solid-state battery includes the negative electrode, a positive electrode, and a solid electrolyte layer between the negative electrode and the positive electrode.

In an example embodiment of the present disclosure, a method for manufacturing a negative electrode for an all-solid-state battery includes preparing a negative electrode current collector containing a first region, and a second region surrounding the first region, performing a plasma treatment selectively on the second region excluding the first region, and forming a coating layer on the negative electrode current collector, and an adhesive force between the coating layer and the second region may be greater than an adhesive force between the coating layer and the first region.

### BRIEF DESCRIPTION OF THE FIGURES

The accompanying drawings are included to provide a further understanding of the present disclosure, and are incorporated in and constitute a part of this specification. The drawings illustrate example embodiments of the present disclosure and, together with the description, serve to explain principles of the present disclosure. In the drawings:

FIG. 1 is a cross-sectional view of an all-solid-state battery according to an example embodiment of the present disclosure;

FIG. 2 is a plan view of a negative electrode current collector according to an example embodiment of the present disclosure;

FIG. 3 is a cross-sectional view of a negative electrode current collector according to an example embodiment of the present disclosure;

FIG. 4 is an enlarged cross-sectional view of region “M” of FIG. 1;

FIG. 5 is an enlarged cross-sectional view of region “M” of FIG. 1;

FIG. 6 is a cross-sectional view of an all-solid-state battery according to an example embodiment of the present disclosure;

FIG. 7 and FIG. 8 are respectively a plan view and a cross-sectional view of an all-solid-state battery according to an example embodiment of the present disclosure;

FIG. 9 is a cross-sectional view of an all-solid-state battery according to an example embodiment of the present disclosure;

FIG. 10 is a cross-sectional view of an all-solid-state battery including a gasket structure according to an example embodiment of the present disclosure;

FIG. 11 is a flowchart illustrating a method for manufacturing a negative electrode according to example embodiments of the present disclosure; and

FIG. 12 to FIG. 16 are schematic diagrams respectively illustrating steps of the manufacturing method.

### DETAILED DESCRIPTION

In order to fully understand the configuration and effect of the present disclosure, example embodiments of the present disclosure are described below in more detail with reference to the accompanying drawings. The present disclosure may, however, be embodied in various forms and should not be construed as limited to the example embodiments set forth herein, and various changes and modifications can be made. Rather, these example embodiments are provided so that this disclosure is thorough and complete, and fully conveys the scope of the present disclosure to those skilled in the art to which the present disclosure pertains.

In this specification, it is understood that, when an element is referred to as being “on” another element, the element may be directly on the other element, or intervening elements may be present therebetween. In the drawings, thicknesses of components may be exaggerated for effectively explaining the technical contents. Like reference numerals or symbols refer to like elements throughout the specification.

Example embodiments described herein are explained with reference to cross-sectional views and/or plan views, which are ideal illustrations of the present disclosure. In the drawings, thicknesses of films and regions are exaggerated for effectively explaining the technical contents. Accordingly, the regions illustrated in the drawings have schematic properties, and the shapes of the regions illustrated in the drawings are intended to illustrate a specific shape of the regions of the element, and are not intended to limit the scope of the disclosure. In various example embodiments of the present specification, terms such as first, second, and third are used to describe various components, but these components should not be limited by these terms. These terms are merely used to distinguish one component from another. Example embodiments described and illustrated herein also include complementary example embodiments thereof.

The terminology used herein is for describing example embodiments and is not intended to limit the present disclosure. In this specification, the singular forms are intended to include the plural forms as well, unless the context clearly indicates otherwise. The terms “comprises” and/or “comprising” used in this specification do not exclude the presence or addition of one or more other components.

In this specification, “combination thereof” may refer to a mixture, a stack, a composite, a copolymer, an alloy, a blend, a reaction product of components, and the like.

In this specification, the phrases such as “A or B,” “at least one among A and B,” “at least one of A or B,” “A, B, or C,” “at least one among A, B, and C,” and “at least one of A, B, or C” may each include any one of the items listed together in the corresponding phrase, among the phrases, or any possible combination thereof.

In this disclosure, the “size” of a particle may indicate, for example, a “particle diameter.” When the particle is a spherical shape, the “particle diameter” of the particle refers to an average particle diameter, and when the particle is not the spherical shape, the particle diameter refers to an average major axis length. The particle diameter of a particle may be measured using a particle size analyzer (PSA). The “particle diameter” of a particle is, for example, an average particle diameter. For example, the average particle diameter is a median particle diameter (D50). The median particle diameter (D50) may be, for example, a particle size corresponding to 50% of the cumulative volume calculated from a side of particles having the small particle size in a particle size distribution measured using a laser diffraction method.

In this disclosure, a “metal” includes both of a metal and a metalloid, such as, e.g., silicon and germanium, in an element state or ionic state.

In this disclosure, an “alloy” indicates a mixture of two or more metals.

In this disclosure, a “positive electrode active material” indicates a positive electrode material capable of lithiation and delithiation.

In this disclosure, a “negative electrode active material” indicates a negative electrode material capable of lithiation and delithiation.

In this disclosure, the “lithiation” and “lithiating” refer to a process of providing lithium to the positive electrode active material or the negative electrode active material.

In this disclosure, the “delithiation” and “delithiating” refer to a process of removing lithium from the positive electrode active material or the negative electrode active material.

In this disclosure, “charge” and “charging” refer to a process of providing electrochemical energy to a battery.

In this disclosure, a “positive electrode” and a “cathode” refer to an electrode in which electrochemical reduction and lithiation occur during a process of discharging.

In this disclosure, a “negative electrode” and an “anode” refer to an electrode in which electrochemical oxidation and delithiation occur during a process of discharging.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

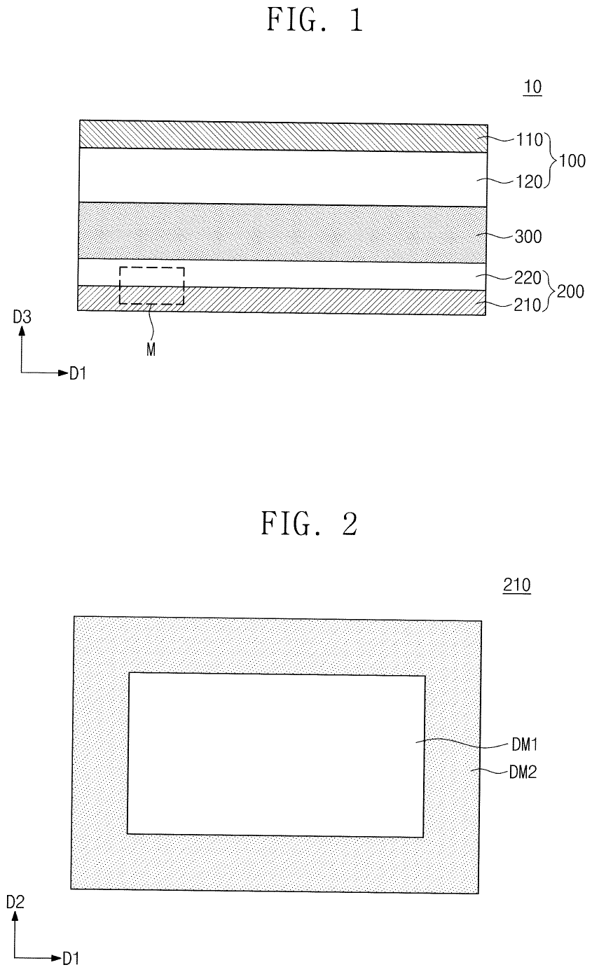

FIG. 1 is a cross-sectional view of an all-solid-state battery 10 according to an example embodiment of the present disclosure.

Referring to FIG. 1, the all-solid-state battery 10 according to an example embodiment may include a positive electrode layer 100, a negative electrode layer 200 opposed to the positive electrode layer 100, and a solid electrolyte layer 300 disposed between the positive electrode layer 100 and the negative electrode layer 200. However, an example embodiment of the present disclosure is not limited thereto, and the all-solid-state battery 10 may further include an additional functional layer, for example, an adhesion improvement layer, disposed between the positive electrode layer 100 and the solid electrolyte layer 300, or between the negative electrode layer 200 and the solid electrolyte layer 300.

### Positive Electrode 100

The positive electrode layer 100 according to an example embodiment may include a positive electrode current collector 110 and a positive electrode active material layer 120 disposed on the positive electrode current collector 110. The positive electrode active material layer 120 may include a positive electrode active material, a solid electrolyte, a conductive material, and a binder.

The positive electrode current collector 110 may provide a reference surface on which the positive electrode active material layer 120 is disposed. The positive electrode current collector 110 may include a plate or a foil containing, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Meanwhile, unlike what is illustrated in FIG. 1, the positive electrode current collector 110 may be omitted in an example embodiment of the present disclosure. Although not illustrated in the drawing, a carbon layer having a thickness in a range of about 0.1 μm to about 4 μm, may further be disposed between the positive electrode current collector 110 and the positive electrode active material layer 120 in order to improve the adhesive force between the positive electrode current collector 110 and the positive electrode active material layer 120.

The positive electrode active material layer 120 may include a positive electrode active material, a solid electrolyte, a conductive material, and a binder.

The positive electrode active material is a material capable of reversibly absorbing and desorbing lithium ions. The positive electrode active material may include a lithium transition metal oxide such as or including at least one of lithium cobalt oxide (LCO), lithium nickel oxide, lithium nickel cobalt oxide, lithium nickel cobalt aluminum oxide (NCA), lithium nickel cobalt manganese oxide (NCM), lithium manganate, and lithium iron phosphate, nickel sulfide, copper sulfide. lithium sulfide, iron oxide, vanadium oxide, or the like, but the example is not necessarily limited thereto. The positive electrode active material may be a single material or a mixture of two or more materials.

The lithium transition metal oxide may be or include a compound represented by any one of, for example, LiₐA_{1-b}B_{b}D₂ (0.90≤a≤1 and 0≤b≤0.5), LiₐE_{1-b}B_{b}O_{2-c}D_{c} (0.90≤a≤1, 0≤b≤0.5, and 0≤c≤0.05), LiE_{2-b}B_{b}O_{4-c}D_{c} (0≤b≤0.5, and 0≤c≤0.05), LiₐNi_{1-b-c}CO_{b}B_{c}D_{α} (0.90≤a≤1, 0≤b≤0.5, 0≤c≤0.05, and 0≤α≤2), LiₐNi_{1-b-c}Co_{b}B_{c}O_{2-α}F_{α} (0.90≤a≤1, 0≤b≤0.5, 0≤c≤0.05, and 0≤α≤2), LiₐNi_{1-b-c}Mn_{b}B_{c}D_{c} (0.90≤a≤1, 0≤b≤0.5, 0≤c≤0.05, and 0≤a≤2), LiₐNi_{1-b- c}Mn_{b}B_{c}O₂₋ₐF_{α} (0.90≤a≤1, 0≤b≤0.5, 0≤c≤0.05, and 0<α<2), LiₐNi_{b}E_{c}G_{d}O₂ (0.90≤a≤1, 0≤b≤0.9, 0≤c≤0.5, and 0.001≤d≤0.1), LiₐNi_{b}Co_{c}Mn_{d}GeO₂ (0.90≤a≤1, 0≤b≤0.9, 0≤c≤0.5, 0≤d≤0.5, and 0.001≤e≤0.1), LiₐNiG_{b}O₂ (0.9≤a≤1 and 0.001≤b≤0.1), LiₐCoG_{b}O₂ (0.90≤a≤1 and 0.001≤b≤0.1), LiₐMnG_{b}O₂ (0.90≤a≤1 and 0.001≤b≤0.1), LiₐMn₂GbO₄ (0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (0≤f≤2), Li_{3-f}Fe₂(PO₄)₃ (0≤f≤2), and LiFePO₄. In these compounds, the capital letter “A” may be or include at least one of Ni, Co, Mn, or a combination thereof, the capital letter “B” may be or include at least one of Al, Ni, Co, Mn, Cr, Fe, Mg, Sr, V, a rare-earth element, or a combination thereof, the capital letter “D” may be or include at least one of O, F, S, P, or a combination thereof, the capital letter “E” may be or include at least one of Co, Mn, or a combination thereof, the capital letter “F” may be or include at least one of F, S, P, or a combination thereof, the capital letter “G” may be or include at least one of Al, Cr, Mn, Fe, Mg, La, Ce, Sr, V, or a combination thereof, the capital letter “Q” may be or include at least one of Ti, Mo, Mn, or a combination thereof, the capital letter “I” may be or include at least one of Cr, V, Fe, Sc, Y, or a combination thereof, and the capital letter “J” may be or include at least one of V, Cr, Mn, Co, Ni, Cu, or a combination thereof.

The positive electrode active material may include, for example, a lithium salt of transition metal oxide having a layered rock salt type structure among the above-described lithium transition metal oxides. The “layered rock salt type structure” is, for example, a cubic rock salt type structure in which oxygen atomic layers and metal atomic layers are alternately and regularly arranged in the <111> direction, and accordingly, each atomic layer forms a two-dimensional plane. The “cubic rock salt type structure” has a sodium chloride-type (NaCl type) structure that is a type of a crystal structure, and in particular, a structure in which face centered cubic lattices (fcc) respectively formed by positive ions and negative ions are disposed to be offset from each other by about ½ (one half) of a ridge of a unit lattice. The lithium transition metal oxide having this layered rock salt type structure may be or include a ternary lithium transition metal oxide, for example, LiNiₓCo_{y}Al_{z}O₂ (NCA), LiNiₓCo_{y}Mn_{z}O₂ (NCM) (0<x<1, 0<y<1, 0<z<1, and x+y+z=1), or the like. In the case where the positive electrode active material includes the ternary lithium transition metal oxide having the layered rock salt type structure, the all-solid-state battery 10 may have increased energy density and improved thermal stability.

The above-described compound, included in the positive electrode active material, may be covered by a covering layer (not shown). In the positive electrode active material, it is also possible to use the above-described compound in combination with a compound added with the covering layer. Meanwhile, the covering layer added to a surface of the positive electrode active material may include, for example, at least one of an oxide, a hydroxide, an oxyhydroxide, an oxycarbonate, or a hydroxycarbonate of a coating element below. The compound included in the covering layer is amorphous or crystalline. The coating element included in the covering layer may include at least one of Mg, Al, Co, K, Na, Ca, Si, Ti, V, Sn, Ge, Ga, B, As, Zr, or a mixture thereof. The covering layer may include, for example, Li₂O—ZrO₂ (LZO), and the like. A method of forming the covering layer is determined within the range in which the property of the positive electrode active material is not adversely affected. The method of forming the covering layer may include, for example, spray coating, a soaking method, and the like.

When the positive electrode active material includes nickel (Ni) as a ternary lithium transition metal oxide such as NCA or NCM, the capacity density of the all-solid-state battery 10 may increase, and thus, an elution of metal in the positive electrode active material may be reduced in a charge state. Consequently, cycle characteristics of the all-solid-state battery 10 in the charge state is improved. Meanwhile, the “cycle characteristics” refer to characteristics representing the level of deterioration of the all-solid-state battery 10 caused by charging/discharging of the all-solid-state battery 10, and the all-solid-state battery 10 having high cycle characteristics may have a low level of deterioration of the all-solid-state battery 10 caused by the charging/discharging, and the all-solid-state battery 10 having low cycle characteristics may have a high level of deterioration of the all-solid-state battery 10 caused by the charging/discharging.

A shape of the positive electrode active material may include a particle shape such as a sphere, oval, and the like. The particle diameter and amount of the positive electrode active material are not particularly limited.

The solid electrolyte may have a particle shape. The solid electrolyte may be dispersed between the positive electrode active materials. The solid electrolyte may include a sulfide-based solid electrolyte having desired or improved lithium ionic conductivity. The sulfide-based solid electrolyte may include at least one of, for example, Li₂S—P₂S₅, Li₂S—P₂S₅-LiX (where, X is or includes a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where, m and n are positive numbers, and the capital letter “Z” is or includes at least one of Ge, Zn, or Ga.), Li₂S—GeS₂, Li₂S—SiS₂—Li₃PO₄, Li₂S—SiS₂—LiₚMO_{q}(where, p and q are positive numbers, and the capital letter “M” is or includes at least one of P, Si, Ge, B, Al, Ga, or In), Li₇₋ₓPS₆₋ₓClₓ (0<x<2), Li₇₋ₓPS₆₋ₓBrₓ (0≤x≤2), and Li₇₋ₓPS₆₋ₓIₓ (0≤x≤2).

The sulfide-based solid electrolyte may be or include an argyrodite-type compound including one or more of, for example, Li₇₋ₓPS₆₋ₓClₓ(0≤x≤2), Li₇₋ₓPS₆₋ₓBrₓ(0≤x≤2), and Li₇₋ₓPS₆₋ₓIₓ(0≤x≤2). For example, the sulfide-based solid electrolyte may be or include an argyrodite-type compound containing one or more of Li₆PS₅Cl, Li₆PS₅Br, and Li₆PS₅I.

In addition, the sulfide-based solid electrolyte may be or include an argyrodite-type compound containing Li₇₋ₐMₐPS_{6-c}X_{c} (0≤a≤2, (0≤c≤2)). Here, X may be or include at least one of F, Br, Cl, or a combination thereof. M may be or include at least one of scandium (Sc), yttrium (Y), titanium (Ti), zirconium (Zr), hafnium (Hf), vanadium (V), niobium (Nb), tantalum (Ta), chrome (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (Tl), silicon (Si), germanium (Ge), tin (Sn), lead (Pb), arsenic (As), antimony (Sb), bismuth (Bi), or a combination thereof.

Alternatively, the solid electrolyte may be the same as a solid electrolyte SE included in a solid electrolyte layer 300 to be described below.

The argyrodite-type solid electrolyte may have a density in a range of about 1.5 g/cc to about 2.0 g/cc. Since the density of the argyrodite-type solid electrolyte is about 1.5 g/cc or greater, the internal resistance of the all-solid-state battery may decrease, and defects such as penetration and short circuit of a solid electrolyte film, caused by formation of lithium dendrites, may be reduced or prevented. The solid electrolyte may have an elastic modulus in a range of, for example, about 15 GPa to about 35 GPa.

The solid electrolyte included in the positive electrode active material layer 120 may have a smaller median average particle diameter (D50) than the average particle diameter of the solid electrolyte included in the solid electrolyte layer 300. For example, the median average particle diameter (D50) of the solid electrolyte included in the positive electrode active material layer 120 may be about 90% or less, about 80% or less, about 70% or less, about 60% or less, about 50% or less, about 40% or less, about 30% or less, or about 20% or less, of the median average particle diameter (D50) of the solid electrolyte SE included in the solid electrolyte layer 300. The median average particle diameter (D₅₀) may be a median diameter measured using, e.g., a laser particle size distribution meter.

The positive electrode active material layer 120 may further include a conductive material. The conductive material may be or include, for example, a carbon-based material, a metal-based material, or a combination thereof. An amount of the conductive material in the positive electrode active material layer 120 may be in a range of about 1 wt % to about 30 wt %, about 1 wt % to about 20 wt %, about 1 wt % to about 10 wt %, about 0.5 wt % to about 5 wt %, about 0.1 wt % to about 1 wt %, or about 1 wt % to about 5 wt % of the total weight of the positive electrode active material layer 120.

The metal-based material may be or include at least one of a metal powder, a metal fiber, or a combination thereof, but is not limited thereto, and any metal-based material that is used as a conductive material in the relevant art may be used.

The conductive material may include carbon. The conductive material may include any material containing a carbon atom that is used as a conductive material in the relevant art without limitation. For example, the conductive material may include crystalline carbon, amorphous carbon, or a combination thereof. The conductive material may include, for example, calcined product of a carbon precursor. For example, the conductive material may include a carbon nano structure.

For example, the conductive material may include porous carbon or non-porous carbon. The porous carbon may include, for example, periodic and regular two-dimensional or three-dimensional pores. The porous carbon may be, for example, carbon black, such as at least one of ketjen black, acetylene black, denca black, thermal black, and channel black, graphite, activated carbon, or a combination thereof. The form of the carbon in the conductive material may include, for example, a particle form, a sheet form, a fibrous form, and the like, but is not limited thereto, and any form of carbon is possible as long as the form of carbon is used in the relevant art as carbon.

According to an example embodiment of the present disclosure, the conductive material may include a fibrous carbon-based material. Since the conductive material includes the fibrous carbon-based material, the positive electrode active material may have more improved electro-conductivity. Since the conductive material includes the fibrous carbon-based material, electron conduction may be readily performed from a surface of the positive electrode active material to the inside thereof. Due to the conductive material, internal resistance of the positive electrode active material layer 120 may decrease, and cycle characteristics of a secondary battery may be further improved.

The positive electrode active material layer 120 may further include a binder. The binder may include a material for binding the positive electrode active material, the solid electrolyte, the conductive material and the like, included in the positive electrode active material layer 120, and improving binding force to the positive electrode current collector 110.

In an example embodiment, an amount of the binder in the positive electrode active material layer 120 may be in a range of, for example, about 0.1 wt % to about 5 wt %, about 0.1 wt % to about 10 wt %, about 0.5 wt % to about 5 wt %, about 1 wt % to about 5 wt %, about 1 wt % to about 3 wt %, or about 0.5 wt % to about 2 wt %, of the total weight of the positive electrode active material layer 120. The binder may also be omitted.

The binder may include, for example, at least one of polyvinylidene fluoride, a styrene butadiene rubber (SBR), polytetrafluoroethylene, polyvinylidene fluoride, vinylidene fluoride/hexafluoropropylene copolymer, polyvinylidene fluoride/hexafluoropropylene copolymer, polyacrylonitrile, polymethylmethacrylate, and the like.

Other than the above-described positive electrode active material, the solid electrolyte, the conductive material, and the binder, the positive electrode active material layer 120 may further include an additive such as a filler, a coating agent, a dispersant, an ionic conductivity auxiliary material, and the like.

### Solid Electrolyte Layer 300

Referring to FIG. 1, a solid electrolyte layer 300 may be provided between the positive electrode layer 100 and the negative electrode layer 200. The solid electrolyte layer 300 may include a sulfide-based solid electrolyte having desired or improved lithium ionic conductivity characteristics. The solid electrolyte in the solid electrolyte layer 300 may be the same as, or different from, the solid electrolyte included in the positive electrode active material layer 120 described above.

In an example embodiment, the solid electrolyte included in the solid electrolyte layer 300 may be amorphous, crystalline, or in a mixed state thereof. In addition, the solid electrolyte may include, for example, at least one of sulfur(S), phosphorus (P), and lithium (Li) as at least an element of the sulfide-based solid electrolyte materials. For example, the solid electrolyte may be or include a material containing Li₂S—P₂S₅. In case of using the material containing Li₂S—P₂S₅ as the sulfide-based solid electrolyte material composing the solid electrolyte, a mixed molar ratio of Li₂S:P₂S₅ is in a range of, for example, about 50:50 to about 90:10.

The sulfide-based solid electrolyte may be or include an argyrodite-type compound including one or more of, for example, Li₂₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be or include an argyrodite-type compound including one or more of Li₆PS₅Cl, Li₆PS₅Br, and Li₆PS₅I.

In addition, the sulfide-based solid electrolyte may be or include an argyrodite-type compound containing Li₇₋ₐMₐPS_{6-c}X_{c} (0≤a≤2 and 0≤c≤2). Here, X may be or include at least one of F, Br, Cl, or a combination thereof. M may be or include at least one of scandium (Sc), yttrium (Y), titanium (Ti), zirconium (Zr), hafnium (Hf), vanadium (V), niobium (Nb), tantalum (Ta), chrome (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (Tl), silicon (Si), germanium (Ge), tin (Sn), lead (Pb), arsenic (As), antimony (Sb), bismuth (Bi), or a combination thereof.

The argyrodite-type solid electrolyte may have a density in a range of about 1.5 g/cc to about 2.0 g/cc. Since the density of the argyrodite-type solid electrolyte is in a range of about 1.5 g/cc or greater, the internal resistance of the all-solid-state battery may decrease, and defects such as penetration and short circuit of a solid electrolyte film, caused by formation of lithium dendrites, may be reduced or prevented. The solid electrolyte has an elastic modulus in a range of, for example, about 15 GPa to about 35 GPa.

The solid electrolyte layer 300 may further include a binder. The binder included in the solid electrolyte layer 300 includes, for example, at least one of a styrene butadiene rubber (SBR), polytetrafluoroethylene, polyvinylidene fluoride, polyethylene, and the like, but is not limited thereto. For example, the binder may include at least one of a styrene butadiene rubber, polytetrafluoroethylene, polyvinylidene fluoride, polyethylene, polyvinyl alcohol, vinylidene fluoride/hexafluoropropylene copolymer, polyvinylidene fluoride/hexafluoropropylene copolymer, polyacrylonitrile, and polymethylmethacrylate. The binder of the solid electrolyte layer 300 may be the same as or different from the binder included in the positive electrode active material layer 120, or the binder included in a first coating layer 220.

### Negative Electrode 200

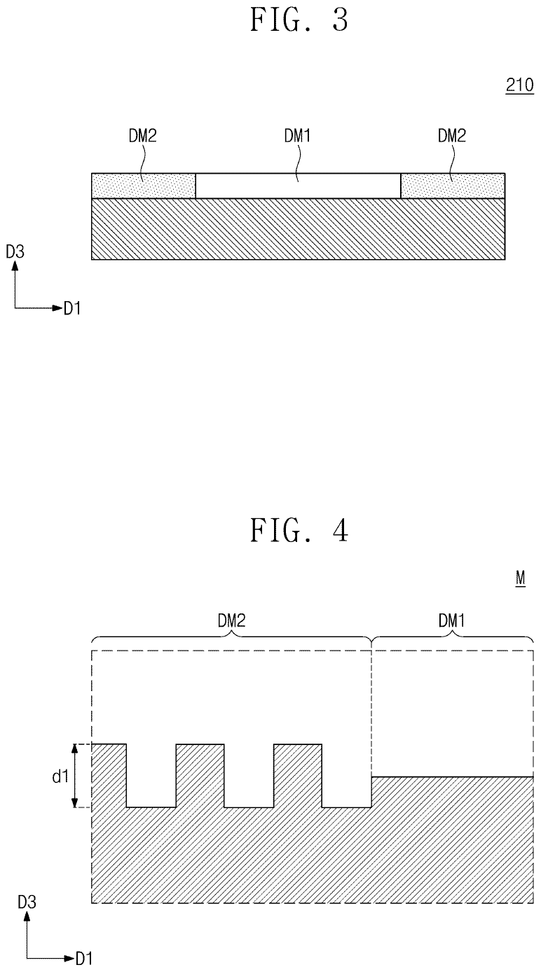

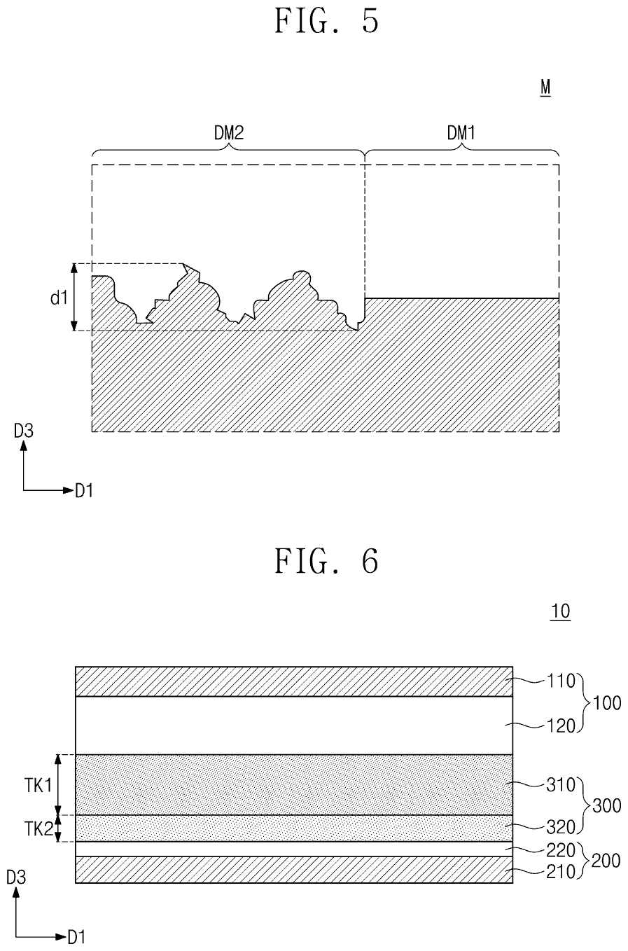

FIG. 2 is a plan view of a negative electrode current collector according to example embodiments of the present disclosure. FIG. 3 is a cross-sectional view of a negative electrode current collector according to example embodiments of the present disclosure. FIG. 4 and FIG. 5 are enlarged views of the region “M” of FIG. 1, which are enlarged cross-sectional views of a boundary surface between the negative electrode current collector and a coating layer. Hereinafter, referring to FIG. 2 to FIG. 5, a negative electrode according to example embodiments of the present disclosure, and an all-solid-state battery including the same are described in more detail.

Referring to FIG. 2 and FIG. 3, a negative electrode current collector 210 according to example embodiments of the present disclosure may include a first region DM1, and a second region DM2 surrounding the first region DM1.

The second region DM2 may refer to a boundary region of the negative electrode current collector 210. For example, the second region DM2 may be a region formed along an outline of the negative electrode current collector 210, and may refer to a region at a given distance from the outline. The first region DM1 may be the remaining region other than the second region DM2, that is, may refer to an inner-side region of the boundary region.

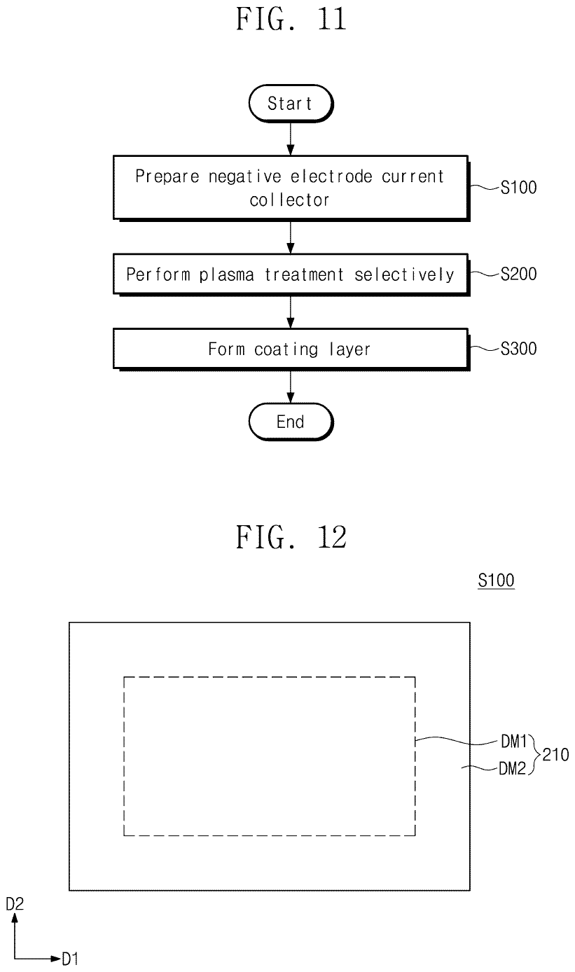

The second region DM2 may be a surface-treated portion. Referring to FIG. 4 and FIG. 5, the second region DM2 may include a plurality of irregularities. In this specification, the irregularities may refer to a structure including at least one concave portion and at least one protruding convex portion. The surface treatment may be, for example, a plasma treatment. A method of performing the plasma treatment is described below with reference to FIG. 11.

The form of the irregularities is not particularly limited. For example, the plurality of irregularities may be formed in a uniform structure (see FIG. 4), and may also be formed in a non-uniform structure (see FIG. 5). For example, the irregularities may have a depth d1 in a range of about 10 nm to about 100 nm. In this specification, the depth d1 of the irregularities may refer to the difference in height between the most concavely sunken portion and the most convexly protruding portion.

According to an example embodiment, a metal oxide film may be formed in the plasma-treated second region DM2. For example, when the plasma treatment is performed under oxygen (O₂) gas, oxidation reaction may occur on a metal current collector surface to form an oxide film. For example, when a copper foil is used as the negative electrode current collector, a copper oxide film may be formed in the second region DM2, and when a stainless-steel foil is used as a negative electrode current collector, a stainless-steel oxide film may be formed in the second region DM2. For example, the protruding part of the irregularities may be portions where the oxide film is formed, and the concave part of the irregularities may be portions where the oxide film is cut off, so that the metal is exposed.

According to an example embodiment, the plasma-treated second region DM2 may include a chemical functional group. For example, in case that organic gas and/or oxygen gas is provided during the plasma treatment, a chemical functional group may be formed on the second region DM2. For example, the functional group formed on the second region DM2 may be or include at least one of a hydroxy group, a carboxyl group, an alkyl group, or a combination thereof.

The surface-treated second region DM2 may have a greater surface roughness (Sa) than that of the first region DM1 which is not surface-treated. For example, the surface roughness of the second region DM2 may be in a range of about 0.7 gf/mm to about 2 gf/mm, or about 0.8 gf/mm to about 1.5 gf/mm. The average surface roughness of the first region DM1 may be in a range of about 0.1 gf/mm to about 0.8 gf/mm, or about 0.3 gf/mm to about 0.7 gf/mm. In this specification, the surface roughness is an index indicating the average change in height of a particular surface, which may be a value obtained by quantitatively evaluating the roughness of the surface in three-dimensional form.

For example, the surface roughness may be measured using, e.g., an atomic force microscope (AFM), and may also be measured in a non-contact manner using a laser or optical instrument.

As described above, since the second region DM2 has a high surface roughness, the second region DM2 may have improved adhesive force to the coating layer 220, compared to the first region DM1. In particular, the rough surface of the second region DM2 may increase the coefficient of friction in the second region DM2, thereby making it challenging for the coating layer 220, formed on the surface of the second region DM2, to slide or move. In addition, some of the material composing the coating layer 220 may penetrate between the irregularities on the surface of the second region DM2. The increase in frictional force and the penetration of material between the irregularities may result in strengthening of the adhesive force between the second region DM2 and the coating layer 220.

Referring to FIG. 4 and FIG. 5 again, the second region DM2 including the irregularities may have a larger surface area than the first region DM1. The larger surface area may further strengthen the adhesive force between the second region DM2 and the coating layer 220. As the surface area increases, the contact area between the second region DM2 and the coating layer 220 may increase, and accordingly, there are increasing physical contact points, resulting in the strengthening of the adhesive force.

In an example embodiment, the adhesive force between the second region DM2 and the coating layer 220 may be in a range of about 5 gf/mm to about 20 gf/mm. In an example embodiment, the adhesive force between the first region DM1 and the coating layer 220 may be in a range of about 1 gf/mm to about 10 gf/mm.

The adhesive force may be evaluated by measuring the force necessary for separating two thin-sheet materials that are bonded to each other. The method of measuring the adhesive force may include, e.g., a 180-degree peel test, a 90-degree peel test, a T-peel test, or the like.

In an example embodiment, the 180-degree/90-degree peel tests may be tests measuring the peel strength by pulling a target object to be measured at 180 degrees/90 degrees, respectively. In particular, a specimen in a thin film formed of or include an upper specimen and a lower specimen is fixed on a flat surface, and then the upper specimen is pulled at about 180 degrees/about 90 degrees from the surface to measure the force.

In an example embodiment, the T-peel test is a test for measuring the peel strength by pulling a T-shaped object to be measured for adhesive force in opposite directions. For example, when a first specimen and a second specimen in a thin film form are bonded to each other, the first specimen and the second specimen are pulled in opposite directions to measure the force.

The negative electrode current collector 210 according to example embodiments of the present disclosure may include both of the second region DM2 which is surface-treated to have improved adhesion, and the first region DM1 which is not surface-treated, so that lithium metal may be plated smoothly between the negative electrode current collector 210 and the coating layer 220 while the adhesion between the negative electrode current collector 210 and the coating layer 220 is desired or improved.

In the case of the all-solid-state battery, since a positive electrode, a negative electrode, and an electrolyte layer are all in solid state, in order to secure electrical conductivity and ionic conductivity, the positive electrode, the electrolyte layer, and the negative electrode stacked in sequence may be bonded tightly to each other. In other words, the positive electrode and the solid electrolyte layer may be bonded tightly, and the negative electrode and the solid electrolyte layer may be bonded tightly. For this, in the all-solid-state battery, a unit cell having the positive electrode, the solid electrolyte layer, and the negative electrode being stacked in sequence may be applied with high pressure.

When the adhesive force between the negative electrode current collector 210 and the coating layer 220 is low, the difference in elongation rate between the negative electrode current collector 210 and the coating layer 220 may cause a problem of separating the negative electrode current collector 210 from the coating layer 220. This may cause a cell to have increased electrical resistance, reduced capacity, and reduced lifespan.

The separation problem of the coating layer 220, caused by the difference in elongation rate, mainly occurs at a boundary portion of the negative electrode current collector 210. In the negative electrode 20 according to example embodiments of the present disclosure, the boundary portion of the negative electrode current collector 220, which is the second region DM2, may be surface-treated, so that the adhesive force of the boundary portion is strengthened, thereby reducing or preventing the separation issues of the coating layer 220.

In the negative electrode 20 according to example embodiments of the present disclosure, the first region DM1 may not be surface-treated in order for smooth plating of lithium metal between the negative electrode current collector 210 and the coating layer 220.

In an example embodiment, the negative electrode 20 may constitute a negative electrode when the lithium metal grows between the current collector 210 and the coating layer 220 during charging of the all-solid-state battery. In the case where a plasma treatment is performed on the entire negative electrode current collector 210, the adhesive force between the negative electrode current collector 210 and the coating layer 220 increases substantially, so that the plating of lithium metal may become challenging between the negative electrode current collector 210 and the coating layer 220, and the lithium plating may occur inside the coating layer 220 or between the coating layer 220 and the solid electrolyte layer 300. This may result in a capacity decrease and a reduction in lifespan characteristics of the negative electrode.

Therefore, in the negative electrode 20 according to example embodiments of the present disclosure, the surface treatment is performed on the second region DM2 where improvement in adhesive force is important, and the surface treatment is not performed on the other region, which is the first region DM1, so that the separation of the coating layer 220 is reduced or suppressed, and the lithium metal may be plated smoothly between the negative electrode current collector 210 and the coating layer 220.

According to example embodiments of the present disclosure, the first region DM1 that is not surface-treated may have a first area, and the second region DM2 that is surface-treated may have a second area. The second area may be equal to or smaller than the first area. For example, a ratio of the second area to the first area may be in a range of about 0.2 to about 1, or about 0.5 to about 1.

When the ratio of the second area is too small, the adhesive force between the negative electrode current collector 210 and the coating layer 220 is low, causing a problem of separating the coating layer 220. When the ratio of the second area is too large, the plating of lithium metal may become challenging between the negative electrode current collector 210 and the coating layer 220. When the ratio of the second area to the first area falls within the above-described ranges, the adhesive force between the negative electrode current collector 210 and the coating layer 220 may be improved, and also the lithium-ion plating on the negative electrode current collector 210 may be facilitated.

According to example embodiments of the present disclosure, the negative electrode current collector 210 may include a material that is unreactive to lithium, e.g., a material forming neither an alloy nor a compound with lithium. Materials constituting the negative electrode current collector 210 includes, for example, at least one of copper (Cu), stainless steel, titanium (Ti), iron (Fe), cobalt (Co), nickel (Ni), and the like, but the example is not necessarily limited thereto, and any material that is used as an electrode current collector can be used. The negative electrode current collector 210 may have a thickness in a range of about 1 μm to about 20 μm, for example, about 5 μm to about 15 μm, and for example, about 7 μm to about 10 μm.

The negative electrode current collector 210 may include one of the above-described metals, or may include an alloy of two or more metals, or a covering material. The negative electrode current collector 210 may be in the form of, for example, a plate or foil.

As described above, the coating layer 220 may cause lithium metal to grow between the coating layer and the negative electrode current collector 210 when the all-solid-state battery is charged. The coating layer 220 may constitute a protecting layer of the lithium metal, and may reduce or suppress deposition and growth of lithium dendrites.

The coating layer 220 may include metal and carbon. For example, the coating layer 220 may include a metal and a carbon-based material.

The carbon-based material may be, e.g., amorphous carbon. The amorphous carbon may be or include, for example, at least one of carbon black (CB), acetylene black (AB), furnace black (FB), ketjen black (KB), graphene, and the like, but is not necessarily limited thereto. The amorphous carbon is a carbon having no crystallinity, or that has very low crystallinity, which is distinguished from crystalline carbon or graphite-based carbon.

The metal may be or include a metal that is capable of forming an alloy or compound with lithium, and for example, may include at least one of gold (Au), platinum (Pt), palladium (Pd), silicon (Si), silver (Ag), aluminum (Al), bismuth (Bi), tin (Sn), and zinc (Zn). Since nickel (Ni) does not form an alloy with lithium, nickel (Ni) may not be included in the coating layer 220.

A mixed ratio of the carbon-based material and the metal may be in a range of about 10:1 to about 1:2, about 5:1 to about 1:1, or about 4:1 to about 2:1 on the basis of the weight, but is not necessarily limited to these ranges, and the ratio may vary according to the characteristics to be required for the all-solid-state battery 10.

The coating layer 220 may further include a binder. The binder may cause the coating layer 220 to be stably formed on the negative electrode current collector 210. That is, the binder may increase binding force of the coating layer 220 to the negative electrode current collector 210.

The binder of the coating layer 220 may be the same as, or different from, the binder included in the positive electrode active material layer 120. The binder may include, for example, at least one of a styrene butadiene rubber (SBR), polytetrafluoroethylene, polyvinylidene fluoride, polyethylene, a vinylidene fluoride/hexafluoropropylene copolymer, a polyvinylidenefluoride/hexafluoropropylene copolymer, polyacrylonitrile, polymethylmethacrylate, and the like, but is not limited thereto. The binder may include a single binder, or a plurality of different binders.

When the amount of the binder is substantially increased in the coating layer 220 in order to improve the binding force between the coating layer 220 and the negative electrode current collector 210, electrical resistance of the negative electrode may increase, and distribution of the binder in the negative electrode may become challenging to control. The increased resistance of the negative electrode may result in reduction of rate capability. When the binder distribution is challenging to control, the lithium metal may be made between the coating layer and the solid electrolyte layer, or inside the coating layer, thereby deteriorating lifespan characteristics of a battery.

Since the negative electrode for an all-solid-state battery according to example embodiments of the present disclosure includes a negative electrode current collector in which the boundary region is surface-treated as described above, sufficient adhesive force may be secured between the negative electrode current collector 210 and the coating layer 220 only with small amounts of the binder. For example, the amount of the binder in the coating layer 220 may be in a range of about 0.1 wt % to about 10 wt %, about 1 wt % to about 8 wt %, or about 5 wt % to about 8 wt % on the basis of 100 wt % of the coating layer.

The coating layer 220 may further include another additive other than the carbon-based material, the metal, and the binder. For example, the coating layer 220 may further include at least one of a filler, a coating agent, a dispersant, an ionic conductivity auxiliary material, and the like.

The coating layer 220 may have a smaller thickness than the thickness of the positive electrode active material layer 120. The thickness of the coating layer 220 may be, for example, in a range of about 50% or less, about 40% or less, about 30% or less, about 20% or less, about 10% or less, or about 5% or less of the thickness of the positive electrode active material layer 120. The thickness of the coating layer 220 may be in a range of, for example, about 1 μm to about 20 μm, about 2 μm to about 10 μm, or about 3 μm to about 7 μm. When the thickness of the coating layer 220 is too small, e.g., less than 1 μm, lithium dendrites, formed between the coating layer 220 and the negative electrode current collector 210, may collapse the coating layer 220, and thus, cycle characteristics of the all-solid-state battery may deteriorate. When the thickness of the coating layer 220 is too large, e.g., more than 20 μm, the energy density of the all-solid-state battery may decrease, and the internal resistance of the all-solid-state battery may increase due to the coating layer 220, and thus, the cycle characteristics of a cell may deteriorate. Meanwhile, although not illustrated in the drawing, a carbon layer may further be included in order to improve the adhesion between the coating layer 220 and the solid electrolyte layer 300.

FIG. 6 is a cross-sectional view of an all-solid-state battery 10 according to another example embodiment of the present disclosure.

Referring to FIG. 6, the solid electrolyte layer 300 may include a first solid electrolyte layer 310 and a second solid electrolyte layer 320. The first solid electrolyte layer 310 may be adjacent to a positive electrode layer 100, and the second solid electrolyte layer 320 may be adjacent to a negative electrode layer 200.

The first solid electrolyte layer 310 and the second solid electrolyte layer 320 may have different thicknesses. The first solid electrolyte layer 310 may have a first thickness TK1, and the second solid electrolyte layer 320 may have a second thickness TK2. The first thickness TK1 may be larger than the second thickness TK2. For example, the first thickness TK1 may be in a range of about 2 times to about 100 times the second thickness TK2.

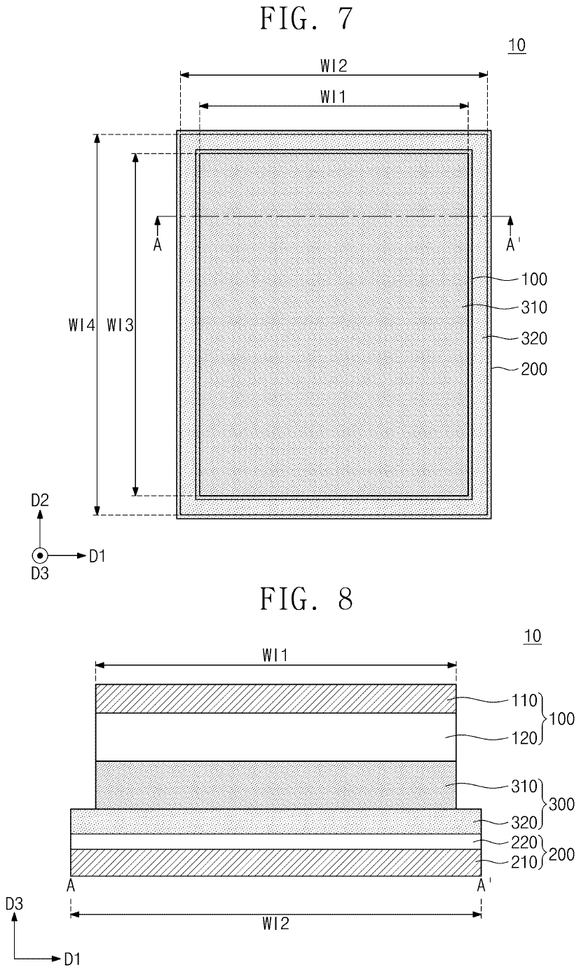

FIG. 7 is a plan view of an all-solid-state battery 10, according to another example embodiment of the present disclosure. FIG. 8 is a cross-sectional view according to line A-A′ of FIG. 7. In this example embodiment, detailed description on technical characteristics overlapping what is described above with reference to FIG. 1 and FIG. 2 is omitted, and the difference therewith is described in detail below.

Referring to FIG. 7 and FIG. 8, the area of a positive electrode layer 100 may be different from the area of a negative electrode layer 200. In particular, the area of the negative electrode layer 200 may be larger than the area of the positive electrode layer 100. The positive electrode layer 100 may completely overlap in the negative electrode layer 200.

According to an example embodiment of the present disclosure, a first solid electrolyte layer 310 may have substantially the same area as the area of the positive electrode layer 100. A second solid electrolyte layer 320 may have substantially the same area as the area of the negative electrode layer 200.

In particular, the first solid electrolyte layer 310 may have a first width WI1 in a first direction D1. The second solid electrolyte layer 320 may have a second width WI2 in the first direction D1. The first width WI1 may be smaller than the second width WI2. The first solid electrolyte layer 310 may have a third width WI3 in a second direction D2. The second solid electrolyte layer 320 may have a fourth width WI4 in the second direction D2. The third width WI3 may be smaller than the fourth width WI4.

The all-solid-state battery 10 according to this example embodiment may be prepared by forming a first stacked body of the positive electrode layer 100 and the first solid electrolyte layer 310, and forming a second stacked body of the negative electrode layer 200 and the second solid electrolyte layer 320, and then laminating the first stacked body and the second stacked body together.

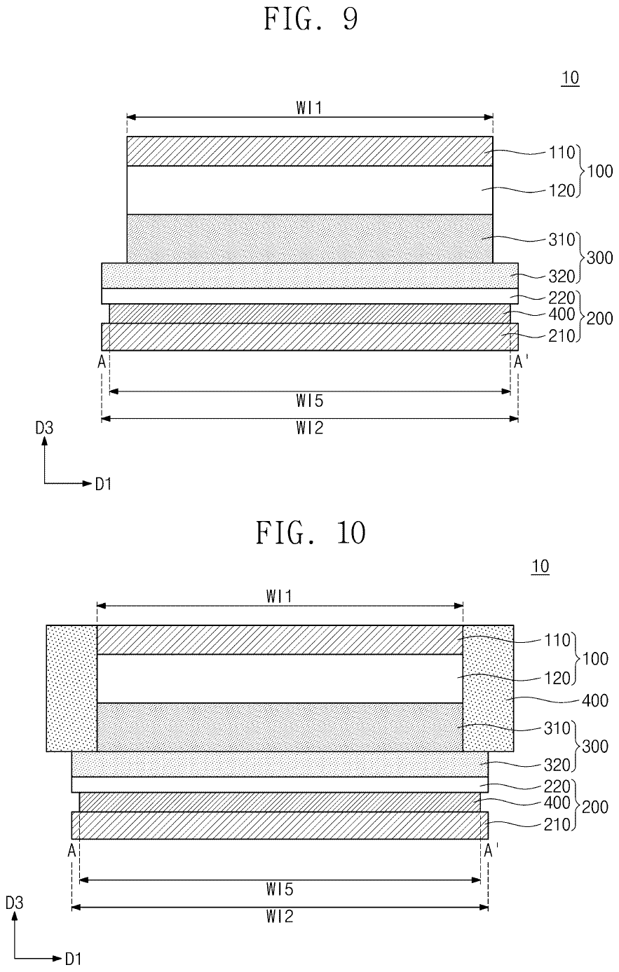

FIG. 9 is a cross-sectional view according to line A-A′ of FIG. 3 illustrating an all-solid-state battery, according to another example embodiment of the present disclosure.

Referring to FIG. 9, a negative electrode layer 200 of the all-solid-state battery 10 may further include a lithium metal layer 400 between a negative electrode current collector 210 and a negative electrode coating layer 220. The thickness of the lithium metal layer 400 may further increase when the all-solid-state battery 10 is charged. The negative electrode coating layer 220 may constitute a protecting layer of the lithium metal layer 400, and may reduce or suppress the growth of lithium dendrites in the lithium metal layer 400.

The lithium metal layer 400 may be a metal thin film including lithium or a lithium alloy. The lithium alloy may be or include, for example, at least one of a Li—Al alloy, a Li—Sn alloy, a Li—In alloy, a Li—Ag alloy, a Li—Au alloy, a Li—Zn alloy, a Li—Ge alloy, a Li—Si alloy, and the like, but is not limited thereto, and any alloy used as the lithium alloy is possible. The lithium metal layer 400 may include one of these alloys or lithium. Alternatively, the lithium metal layer 400 may include various types of alloys.

The lithium metal layer may be, for example, a plated layer. For example, the lithium metal layer may be plated between the coating layer 220 and the negative electrode current collector 210 in a charging process of the all-solid-state battery.

In another example embodiment of the present disclosure, the lithium metal layer in the negative electrode 200 may be provided, for example, between the negative electrode current collector 210 and the coating layer 220 before the all-solid-state battery is assembled. In the case where the lithium metal layer is disposed between the negative electrode current collector 210 and the coating layer 220 before the assembly of the all-solid-state battery, the lithium metal layer constitutes a lithium storage because the lithium metal layer is a metal layer containing lithium. For example, a lithium foil may be disposed between the negative electrode current collector 210 and the coating layer 220 before the all-solid-state battery is assembled.

When the lithium metal layer is plated by the charging before the all-solid-state battery is assembled, since the lithium metal layer is not included during the assembly of the all-solid-state battery, the energy density of the all-solid-state battery may increase. When charged, the all-solid-state battery may be charged beyond the charge capacity of the coating layer 220. That is, the coating layer 220 is overcharged. In the beginning of the charging, the coating layer 220 may absorb lithium. When the charging is performed beyond the capacity of the coating layer 220, lithium may be plated between, for example, the negative electrode coating layer 220 and the negative electrode current collector 210. As a result, a metal layer may be formed by the plated lithium.

The metal layer may mainly include lithium (that is, metal lithium). In discharging, the lithium in the lithium metal layer may be ionized to move to the positive electrode 100. In other words, lithium may be used as a negative electrode active material in the all-solid-state battery. In addition, since the coating layer 220 covers the lithium metal layer, the coating layer 220 may protect the lithium metal layer, and reduce or suppress deposition and growth of lithium dendrites. Therefore, the coating layer 220 may reduce or suppress short circuit and capacity decrease of the all-solid-state battery, and may improve cycle characteristics of the all-solid-state battery.

When the lithium metal layer is formed by the charging after assembly of the all-solid-state battery, the negative electrode 200, which is a region including the negative electrode current collector 210, the coating layer, and a region therebetween, may be a Li-free region in which lithium (Li) is not included in an initial state of the all-solid-state battery, or in a state after the all-solid-state battery is completely discharged.

The lithium metal layer 400 may have a fifth width WI5 in a first direction D1. The fifth width WI5 may be equal to or larger than the first width WI1. The fifth width WI5 may be equal to or smaller than the second width WI2. For example, the fifth width WI5 may be larger than the first width WI1, and smaller than the second width WI2.

FIG. 10 is a cross-sectional view of an all-solid-state battery according to another example embodiment of the present disclosure.

Referring to FIG. 10, the all-solid-state battery 10 may include a gasket structure 400. The gasket structure 400 may fill a step on a side surface of the all-solid-state battery 10 caused by a difference in area between a first stacked body and a second stacked body. The gasket structure 400 may surround side surfaces of the first stacked body of the all-solid-state battery 10 in first and second directions D1 and D2. For example, the thickness of the gasket structure 400 may be substantially equal to the thickness of the first stacked body. Accordingly, even though the first stacked body and the second stacked body, which have different areas, are stacked and pressed, damage on the step of the side surface of the all-solid-state battery may be reduced or prevented by the gasket structure 400. The “substantially equal thickness' may be defined as the thickness that is sufficient to reduce or prevent damage on the step of the side surface of the all-solid-state battery despite the stacking and pressing of the first stacked body and the second stacked body having different areas.

### Method for Manufacturing Negative Electrode

FIG. 11 is a flowchart illustrating a method for manufacturing a negative electrode for an all-solid-state battery, according to example embodiments of the present disclosure. FIG. 12 to FIG. 16 are schematic diagrams respectively illustrating steps of the manufacturing method. Hereinafter, referring to FIG. 11 to FIG. 16, the method for manufacturing a negative electrode for an all-solid-state battery according to example embodiments of the present disclosure is described in detail.

Referring to FIG. 11, the method for manufacturing a negative electrode for an all-solid-state battery, according to an example embodiment, may include preparing a negative electrode current collector containing a first region and a second region surrounding the first region (S100); performing a plasma treatment selectively on the second region excluding the first region (S200); and forming a coating layer on the negative electrode current collector (S300).

Referring to FIG. 12, the preparing of the negative electrode current collector (S100) may include setting the first region DM1 and the second region DM2 surrounding the first region DM1 on the negative electrode current collector 210. The second region DM2 may be set as a boundary region of the negative electrode current collector 210. For example, the second region DM2 may be formed along an outline of the negative electrode current collector 210, and may be defined as a region at a given distance from the outline. The first region DM1 may be the remaining region except the second region DM2, that is, may be set as an inner-side region except the boundary region. The second region may be set to have an area that is equal to or smaller than the area of the first region. For example, a ratio of the area of the second region to the area of the first region may be in a range of about 0.5 to about 1.

The negative electrode current collector 210 may include at least one metal such as or including at least one of copper (Cu), stainless steel, titanium (Ti), iron (Fe), cobalt (Co), and nickel (Ni). The negative electrode current collector 210 may include one of the above-described metals, or may include an alloy of two or more metals or a covering material. The negative electrode current collector 210 may be in the form of or include, for example, a plate or foil.

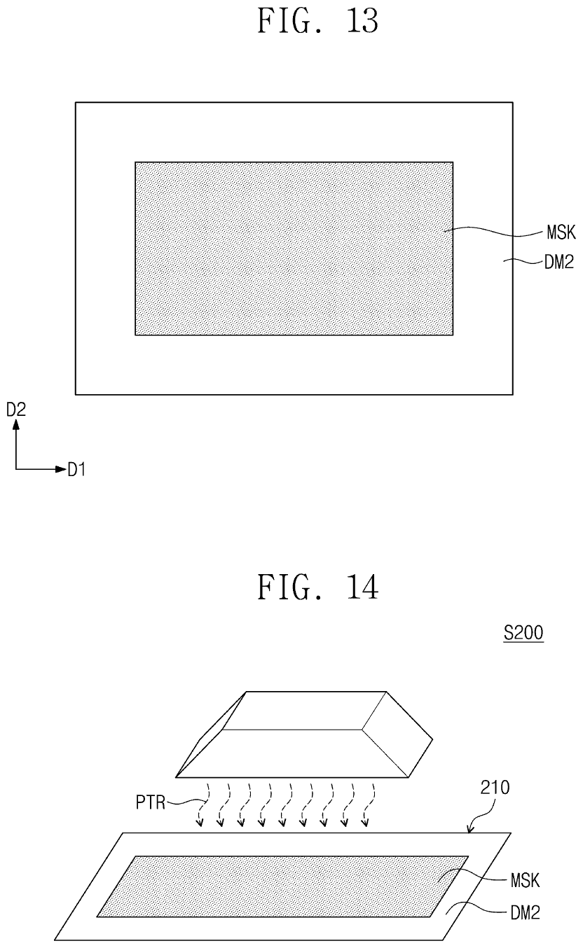

Referring to FIG. 13, the performing of the plasma treatment selectively on the second region DM2 excluding the first region DM1 may include providing a masking member MSK onto the first region DM1 to mask the first region DM1. The material of the masking member MSK is not particularly limited, and may include, for example, a polymer film, or a metal film.

The polymer film may include at least one of polyethylene terephthalate (PET), polyethylene (PE), polypropylene (PP), or a combination thereof. The metal film may include at least one of copper (Cu), aluminum (Al), iron (Fe), cobalt (Co), or a combination thereof.

Referring to FIG. 14, the performing of the plasma treatment PTR on the second region DM2 (S300) may include supplying gas for generating plasma, and applying a frequency to a discharge electrode to generate plasma. The supplied gas may be or include, for example, oxygen or an inert gas (e.g., Ar, N₂), and may be supplied at a flow rate in a range of about 10 sccm to about 1000 sccm. The frequency applied to the discharge electrode may be in a range of, for example, about 10 kHz to about 1000 kHz. The plasma treatment may be performed for a duration in a range of about 1 second to about 3000 seconds. When the plasma treatment is performed in the above-described conditions, the effect of improving adhesive force of the second region DM2 through the surface treatment may be improved or maximized.

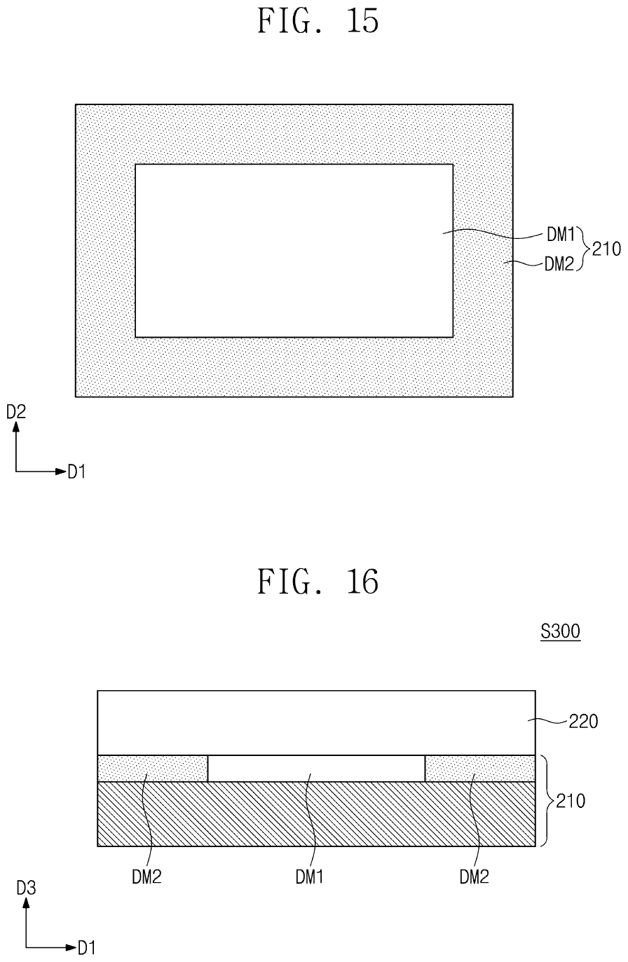

After removing the masking member that masks the first region DM1 (see FIG. 15) after the plasma treatment, a negative electrode current collector 210 in which the plasma treatment is performed selectively only on the second region DM2 may be obtained. The second region DM2, which is plasma-treated, may include a plurality of irregularities. The plurality of irregularities may be formed in a uniform structure, or also formed in a non-uniform structure. For example, the irregularities may have a depth in a range of about 100 nm to about 10 μm. The second region may have a surface roughness in a range of about 0.7 gf/mm to about 2 gf/mm, or a range of about 0.8 gf/mm to about 1.5 gf/mm.

Referring to FIG. 16, a coating layer 220 may be formed on the negative electrode current collector 210 including the first region DM1 and the second region DM2. The forming of the coating layer 220 may include applying a slurry for forming the coating layer onto the negative electrode current collector 210. The slurry for forming the coating layer may include a carbon-based material and a metal, and may further include a binder.

The adhesive force between the formed coating layer 220 and the second region DM2 may be in a range of about 5 gf/mm to about 20 gf/mm. The adhesive force between the formed coating layer 220 and the first region DM1 may be in a range of about 1 gf/mm to about 10 gf/mm.

Hereinafter, the present inventive concepts are described in more detail through an example and comparative examples. However, the example is only an example, and the scope of the present inventive concepts is not limited thereto.

### Example: Manufacture of Negative Electrode

Preparing Negative Electrode Current Collector a Partial Region of which is Surface-Treated:

A stainless-steel (SUS) foil having a thickness of about 10 μm was prepared as a primary negative electrode current collector. A second region was set in a uniform thickness along an outline of the primary negative electrode current collector, and an inner-side region of the second region was set as a first region. The first and second regions were set such that the ratio of the area of the second region to the area of the first region became about 0.7.

The first region was masked by a masking member (PE film), and plasma surface modification was performed on the second region using a capacitively coupled plasma device (FEMTO SCIENCE, Korea). The frequency of the capacitively coupled plasma device was adjusted to the range of about 1 kHz to about 100 kHz, and the power was adjusted to about 1 W to about 100 W.

In a reactive ion etching (RIE) mode, an upper substrate was used as ground, a lower substrate was applied with a frequency of about 50 kHz and a power of about 100 W. At this time, about 20 sccm of oxygen gas was supplied to perform a plasma treatment under an operation pressure of about 4.5×10⁻¹ torr or less.

The masking member was removed from the primary negative electrode current collector, which was plasma-treated, to obtain a negative electrode current collector in which only the second region was plasma-treated.

### Manufacturing Negative Electrode:

Mixed powder in which carbon black (CB) and silver (Ag) particles were mixed in a weight ratio of about 3:1 was added to distilled water which is a solvent, a binder solution, including a SBR binder in the amount of about 3 wt % and a CMC binder in the amount of about 6 wt %, was added thereto to prepare a mixed solution. The mixed solution was agitated to prepare a coating layer slurry. The prepared coating layer slurry was applied onto the prepared negative electrode current collector using a bar coater, and dried in the air at about 80° C. for about 10 minutes to form a coating layer on the negative electrode current collector. The amount of binder in the formed coating layer was about 6.5 wt %.

### Comparative Example 1

A negative electrode was manufactured in the same manner as the example, with a difference that a stainless-steel foil having a thickness of about 10 μm that is not surface-treated was used for a negative electrode current collector.

### Comparative Example 2

A stainless-steel foil having a thickness of about 10 μm that is not surface-treated was used for a negative electrode current collector.

A negative electrode was manufactured in the same manner as the example, with a difference that in a preparation process of a coating layer slurry, the amount of binder was increased up to about 10 wt % in the coating layer slurry.

### Comparative Example 3

A negative electrode was manufactured in the same manner as the example, with a difference that the surface treatment was performed on the entire stainless-steel foil having a thickness of about 10 μm without distinction between the first region and second region.

Manufacturing Example: Manufacture of all-Solid-State Battery

### Positive Electrode Active Material:

LiNi_{0.8}Co_{0.15}Mn_{0.05}O₂ (NCM) powder was prepare as a positive electrode active material.

### Positive Electrode Layer:

LiNi_{0.8}Co_{0.15}Mn_{0.05}O₂ (NCM) powder, described above, was prepare as a positive electrode active material. A crystalline argyrodite-type solid electrolyte (Li₆PS₅Cl) was prepared as a solid electrolyte. A polytetrafluoroethylene (PTFE) binder (Teflon binder of Dupont) was prepared as a binder. Carbon nanofiber (CNF) was prepared as a conductive material. These materials were mixed in a weight ratio of the positive electrode active material: the solid electrolyte: the conductive material: the binder=about 84.2:11.5:2.9:1.4, and the mixture was molded large in a sheet shape to prepare a positive electrode sheet. The prepared positive electrode sheet was compressed onto a positive electrode current collector made of a carbon-coated aluminum foil having a thickness of about 18 μm to prepare a positive electrode layer. The thickness of a positive electrode active material layer included in the positive electrode layer was about 100 μm.

### Negative Electrode Layer:

The negative electrode, prepared according to each of Example 1 and Comparative Examples 1 to 3, was used as a negative electrode layer.

### Solid Electrolyte Layer:

An argyrodite-type solid electrolyte Li₆PS₅Cl was added to an isobutylyl isobutylate binder solution, in which an acrylate-based polymer was added, to prepare a solid electrolyte solution (the solid content was about 50 wt %, and the mixed ratio of the solid electrolyte and the binder was about 98.7:1.3 in a weight ratio).

The solid electrolyte solution was applied onto an expanded polytetrafluoroethylene film, and dried at about 60° C. for about 2 hours to prepare a solid electrolyte layer having a thickness of about 100 μm.

### Manufacturing All-Solid-State Battery:

The negative electrode layer, the solid electrolyte layer, the positive electrode layer, prepared as above, were stacked in sequence. The stacked body was sealed in a pouch form, and warm isostatic press (WIP) was applied onto the sealed stacked body at a high temperature of about 80° C., about 500 MPa, and for about 30 minutes to manufacture an all-solid-state battery.

### Evaluation Example 1: Evaluation on Lifespan Characteristics of all-Solid-State Battery

Evaluation on lifespan characteristics for full cells, manufactured according to the manufacturing examples, was conducted. The lifespan characteristics were evaluated using the following charging and discharging test. The charging and discharging test were performed by placing the all-solid-state battery into a constant temperature oven at about 45° C.

A first cycle was performed by charging at a constant current of about 0.33 C for about 3 hours until a battery voltage reached about 4.25 V and charging at a constant voltage of about 4.25 V until the current reached about 0.1 C, then leaving to rest for about 10 minutes, and then discharging at a constant current of about 0.33 C for about 3 hours until the battery voltage reached about 2.5 V and leaving to rest for about 10 minutes.

From a second cycle, charging and discharging were performed up to a 100th cycle under the same conditions as the first cycle. The results of lifespan characteristics were listed in Table 1 below. In Table 1, the capacity retention rate was represented by Mathematical Equation 1 below.

### Mathematical Equation 1:

$$Capacity retention rate [ \% ] = \text{} [ discharge capacity at the 100 th cycle / \text{} discharge capacity at the first cycle ] \times 100$$

TABLE 1

| | | Amount | Capacity |
|---|---|---|---|
| | Whether surface- | of binder | retention |
| | treated or not | (wt %) | rate (%) |
| Example | Boundary portion ◯ | 6.5 | 86.5 |
| Comparative Example 1 | X | 6.5 | 82.3 |
| Comparative Example 2 | X | 10 | 83.4 |
| Comparative Example 3 | Entire region ◯ | 6.5 | 66.6 |

Referring to Table 1, it can be seen that the all-solid-state battery according to the example had desired or improved lifespan characteristics compared to the all-solid-state batteries according to the comparative examples.

### Evaluation Example 2: Evaluation on Rate Capability of all-Solid-State Battery

Evaluation on the rate capability for the full cells, manufactured according to the manufacturing examples, was conducted. The rate capability was evaluated by the following charging and discharging test.

The lithium batteries were charged with a constant current at a current of about 0.1 C rate and about 25° C. until a voltage reached about 4.25 V (vs. Li), and then cut off at a current of about 0.05 C rate while maintained with about 4.25 V in a constant voltage mode. Next, the batteries were discharged at a constant current of about 0.1 C rate until the voltage reached about 2.8 V (vs. Li) in the end of discharge (formation cycle). The lithium battery with the formation cycle complete was charged and discharged one time at about 25° C. and at each C-rate of about 0.1 C, about 0.33 C, and about 1.0 C (about 4.25 V of charge voltage and about 2.5 V of discharge voltage), and the discharge capacity for each C-rate was measured.

The rate capability was evaluated according to Mathematical Equation 2 below, and the results were listed in Table 2 below.

$$Mathematical Equation 2$$

$$Rate capability by C - rate [ \% ] = [ discharge capacity at each C - rate / discharge capacity at 0.1 C - rate ] \times 100$$

TABLE 2

| | Rate capability (%) | | |
|---|---|---|---|
| | 0.1 C | 0.33 C | 1.0 C |
| Example | 100 | 92.6 | 81.4 |
| Comparative Example 1 | 100 | 91.4 | 78.1 |
| Comparative Example 2 | 100 | 90.6 | 74.4 |
| Comparative Example 3 | 100 | 92.1 | 81.4 |

Referring to Table 2, it can be seen that the all-solid-state battery according to the example had a desired or improved rate capability compared to the all-solid-state batteries according to the comparative examples.

A negative electrode for an all-solid-state battery according to examples of the present disclosure may include a negative electrode current collector in which only a partial region is plasma-treated. Since the plasma treatment is performed only on a partial region of the negative electrode current collector, adhesion between the negative electrode current collector and a coating layer may be improved, and a lithium metal layer may grow smoothly between the negative electrode current collector and the coating layer.

Although the example embodiments of the present disclosure have been described with reference to the accompanying drawings, it is understood that the present disclosure should not be limited to these example embodiments, various changes and modifications can be made within the scope of the claims, the detailed description of the present disclosure, and the accompanying drawings, also fall within the scope of the present disclosure.

What is claimed is:

1. A negative electrode for an all-solid-state battery, the negative electrode comprising:
a negative electrode current collector; and
a coating layer on the negative electrode current collector,
wherein the negative electrode current collector comprises a first region and a second region surrounding the first region, and
the second region comprises a plurality of irregularities.

2. The negative electrode of claim 1, wherein an adhesive force between the coating layer and the second region is greater than an adhesive force between the coating layer and the first region.

3. The negative electrode of claim 1, wherein a surface roughness (Sa) of the first region is less than a surface roughness of the second region.

4. The negative electrode of claim 1, wherein the plurality of irregularities is formed through a plasma treatment.

5. The negative electrode of claim 1, wherein a ratio of an area of the second region to an area of the first region is in a range of about 0.5 to about 1.

6. The negative electrode of claim 1, wherein the coating layer comprises a metal and a carbon-based material.

7. The negative electrode of claim 6, wherein:
the coating layer further comprises a binder; and
an amount of the binder in the coating layer is in a range of about 1 wt % to about 8 wt % on the basis of 100 wt % of the coating layer.

8. The negative electrode of claim 1, further comprising a lithium metal layer between the negative electrode current collector and the coating layer.

9. An all-solid-state battery comprising:
the negative electrode according to claim 1;
a positive electrode; and
a solid electrolyte layer between the negative electrode and the positive electrode.

10. The all-solid-state battery of claim 9, wherein the solid electrolyte layer comprises a sulfide-based solid electrolyte.

11. The all-solid-state battery of claim 9, wherein the positive electrode comprises a positive electrode active material and a sulfide-based solid electrolyte.

12. A method for manufacturing a negative electrode for an all-solid-state battery, the method comprising:
preparing a negative electrode current collector comprising a first region and a second region surrounding the first region;
performing a plasma treatment selectively on the second region excluding the first region; and
forming a coating layer on the negative electrode current collector;
wherein an adhesive force between the coating layer and the second region is greater than an adhesive force between the coating layer and the first region.

13. The manufacturing method of claim 12, wherein the performing of the plasma treatment selectively on the second region comprises applying a frequency in a range of about 1 kHz to about 100 kHz to a discharge electrode.

14. The manufacturing method of claim 12, wherein the performing of the plasma treatment selectively on the second region comprises supplying at least one of oxygen, inert gas, and a combination thereof, at a flow rate in a range of about 10 sccm to about 1000 sccm.

15. The manufacturing method of claim 12, wherein the plasma treatment is performed for a duration in a range of about 1 second to about 3000 seconds.

16. The manufacturing method of claim 12, wherein the performing of the plasma treatment selectively on the second region comprises providing a masking member onto the first region to mask the first region.

17. The manufacturing method of claim 12, wherein the performing of the plasma treatment selectively on the second region comprises forming a plurality of irregularities on the second region.

18. The manufacturing method of claim 12, wherein a ratio of an area of the second region to an area of the first region is in a range of about 0.5 to about 1.

19. The manufacturing method of claim 12, wherein the coating layer comprises a metal and a carbon-based material.

20. The manufacturing method of claim 12, wherein the coating layer further comprises a binder.
